(19) United States
(12) Patent Application Publication
(10) Pub. No.: US 2026/0285464 A1
(43) Pub. Date: Sep. 24, 2026

(54) RING-SHAPED OR TUBULAR COMPONENT, IN PARTICULAR A STERN BUSH TUBE OF A WATERCRAFT, AND METHOD FOR PRODUCING SUCH A COMPONENT

(71) Applicant: SKF MARINE GMBH, Hamburg (DE)

(72) Inventor: Jonas CHUN, Hamburg (DE)

(21) Appl. No.: 19/561,683

(22) Filed: Mar. 10, 2026

(30) Foreign Application Priority Data
Mar. 18, 2025 (DE) 102025110277.5

(51) Int. Cl. B63H 23/32; B29C 65/66; B33Y 10/00; B33Y 80/00

(52) U.S. Cl. CPC B63H 23/321; B29C 65/665; B33Y 80/00; B33Y 10/00

(57) ABSTRACT

A method for producing a ring-shaped or tubular component, such as a stern bush tube for a watercraft, includes using an additive manufacturing process to deposit a metal heated to above a first predetermined temperature in successive circular layers to form a metal sleeve, introducing a tube piece made of plastic into the metal sleeve while a temperature of the metal sleeve remains above a second temperature, and actively or passively cooling the metal sleeve to form a press fit between the tube piece and the metal sleeve. Also a component produced by the method.

### CROSS-REFERENCE

This application claims priority to German patent application no. 10 2025 110 277.5 filed on Mar. 18, 2025, the contents of which are fully incorporated herein by reference.

### TECHNOLOGICAL FIELD

The present disclosure relates to a method for producing a ring-shaped or tubular component and to a ring-shaped or tubular component produced by the method

### BACKGROUND

Ring-shaped or tubular plastic components offer advantages such as lower weight and significantly simplified availability of raw material as compared to corresponding metal components, which leads to a reduction in working effort and storage effort and to financial savings. However, further processing of such plastic components, for example by means of a lathe, is often problematic, in particular in the case of tubes having thin walls because the fixed clamping of the thin-walled tubes, which is advantageous for such processing, causes the plastic material to deform. In the case of particularly long thin-walled plastic components, it is moreover the case that precise compliance with the dimensional specifications is often barely possible, in particular because vibrational deflections occur during vertical turning and deformations in the inner and outer diameters arise during horizontal turning.

### SUMMARY

The present disclosure avoids the above-mentioned disadvantages, and in particular allows for the improvement of ring-shaped or tubular components.

A method according to the disclosure serves for producing a ring-shaped or tubular component. In this case, a metal sleeve is produced by additive manufacturing, and a plastic tube piece is introduced into the interior of the metal sleeve, which still contains residual heat from the additive manufacturing process (and whose temperature is thus in particular higher than its ambient temperature).

During the introduction, the metal sleeve and the plastic tube piece are thus moved relative to one another, the introduction being able to comprise in particular pushing the plastic tube piece into the metal sleeve and/or pushing the metal sleeve onto the plastic tube piece.

By allowing the metal sleeve to (passively) cool and/or-possibly in a temporally alternating manner-(actively) cooling it, according to the method according to the disclosure, press fitting of the plastic tube piece in the metal sleeve is effected after the introduction. Thus, in a method according to the disclosure, the press fit results from shrinkage of the metal sleeve as it cools down, an outer diameter of the plastic tube piece thus already corresponding substantially to an inner diameter of the metal sleeve during the introduction.

A component according to the disclosure is ring-shaped or tubular and comprises a metal sleeve and a plastic tube piece fixed therein by means of a press fit. The ring-shaped or tubular component can be produced in particular by means of an embodiment of a method according to the disclosure.

A length of the plastic tube piece, as measured in the direction of its central axis, may, in the method according to the disclosure or in the case of a component according to the disclosure, be smaller than its outer diameter, as measured radially with respect to the central axis, so that the plastic tube piece can be described as being ring-shaped. Alternatively, the length may be at least as large as the outer diameter, so that the plastic tube piece (despite the designation as “piece” selected here) can be considered to be tubular. The same applies to the metal sleeve and the component as a whole.

In particular, the ring-shaped or tubular component preferably has been or is formed rotationally symmetrically about its central axis.

The metal sleeve of the component produced by means of a method according to the disclosure or of the component according to the disclosure advantageously stabilizes the plastic tube piece enclosed therein. In this way, undesired deformations or vibrations can be avoided or at least reduced in the case of the component being clamped into a machine (for example into a horizontal or vertical lathe). Conversely, the plastic tube piece stabilizes the preferably thin-walled metal sleeve, too, and thus advantageously allows it to be machined even in the case of very narrow tolerances.

The present disclosure moreover allows the wall, jointly formed from the metal sleeve and the plastic tube piece, of the component to be formed to be particularly thin and, at the same time, nevertheless allows the possibility of precise further processing. Due to the press fitting of the plastic tube piece in the metal sleeve, special separate connecting means such as adhesives, screws or rivets can advantageously be dispensed with.

Furthermore, the covering of the plastic tube piece by the metal sleeve advantageously allows a simple connection of a plurality of the ring-shaped or tubular components (in particular for producing tubes of any desired length): For this purpose, it is possible to create a pocket contour at at least one of the plurality of components in the connecting region, into which another of the components can then be plugged; the connection can then additionally be fixed by means of screws introduced from the outside (radially). By contrast, conventional pure ring-shaped or tubular plastic components, on account of their elasticity, are often difficult to connect without a thermal process (for example friction welding).

The required heat is provided in the method according to the disclosure by the residual heat of the additive manufacture, during which the metal is melted successively. Reheating of the component is thus unnecessary for the shrinkage, which means a saving of energy and production outlay.

In particular, the metal sleeve, during the introduction of the plastic tube piece into its interior, preferably has a temperature which is at least as high as a melting temperature of the plastic tube piece (that is to say its material). In this way, the plastic tube piece is incipiently melted during shrinkage, so that the cooling gives rise to an adhesive effect between the metal sleeve and the plastic tube piece and the component is thus made to be particularly durable.

According to advantageous embodiments, during its additive manufacture, the metal sleeve is produced with a multiplicity of unevennesses, at least in its inner surface. During the shrinkage, the unevennesses give rise to a mechanical connection to the plastic tube piece, which is thereby stiffened further. In particular in embodiments in which, moreover, the temperature of the metal sleeve during the introduction of the plastic tube piece is, as mentioned, above the melting temperature thereof, it is possible for such interengagement of the uneven inner surface of the metal sleeve and the outer surface of the plastic tube piece to be effected, which ensures a particularly stable mechanical connection.

The plastic tube piece of a ring-shaped or tubular component according to the disclosure or the plastic tube piece introduced into the metal sleeve in a method according to the disclosure may comprise in particular at least in part of a thermoset or a thermoplastic, such as for example thermoplastic polyurethane (TPU). It can preferably be manufactured by injection moulding; the method according to the disclosure may include such manufacturing of the plastic tube piece by injection moulding. The connection by a press fit in this case makes it possible in particular to dispense with removal of a release agent, which serves for detachment of the plastic tube piece from its casting mould, before the introduction of the plastic tube piece into the metal sleeve. This means a reduction in the working effort.

Preferably, the lengths of the plastic tube piece and the metal sleeve of the component according to the disclosure or produced by a method according to the disclosure, as measured in the direction of the respective central axes, substantially correspond; in particular, the length of the metal sleeve is preferably at least 90% or at least 95% of the length of the plastic tube piece and/or, conversely, the length of the plastic tube piece is at least 90% or at least 95% of the length of the metal sleeve. The method may comprise shortening the metal sleeve or the plastic tube piece according to such length ratios after the introduction or even after effecting the press fit.

A (constant or mean) outer diameter of the component, as measured perpendicularly to its central axis, may be at least 8 cm or at least 9 cm and/or at most 50 cm, at most 25 cm or at most 12 cm. In alternative embodiments, such a (constant or mean) outer diameter of the component may be at least 50 cm, at least 90 cm or at least 120 cm and/or at most 170 cm or at most 160 cm. Thus, with the production of the component, the metal sleeve is in each case produced with a corresponding outer diameter.

An aspect of the disclosure comprises a method for producing a ring-shaped or tubular component (such as a stern bush tube for a watercraft) that includes using an additive manufacturing process to deposit a metal heated to above a first predetermined temperature in successive circular layers to form a metal sleeve, introducing a tube piece comprising a plastic into the metal sleeve while a temperature of the metal sleeve remains above a second temperature, and actively or passively cooling the metal sleeve to form a press fit between the tube piece and the metal sleeve.

The ring-shaped or tubular component may in particular be a stern tube bush of a watercraft or a bush for sealing (which may also belong to a watercraft).

### BRIEF DESCRIPTION OF THE DRAWINGS

The present disclosure will be discussed in more detail below on the basis of drawings, wherein:

FIG. 1 illustrates a step of producing an exemplary metal sleeve by additive manufacturing according to the disclosure.

FIG. 2 illustrates the introduction of an exemplary plastic tube piece into the metal sleeve of FIG. 1, which metal sleeve still contains residual heat, as a further step of the method according to the disclosure.

FIG. 3 illustrates the ring-shaped or tubular component produced after effecting a press fit with the method according to the disclosure.

### DETAILED DESCRIPTION

Reference signs for elements that correspond to one another are in this case used throughout the figures and will possibly not be described again for each figure.

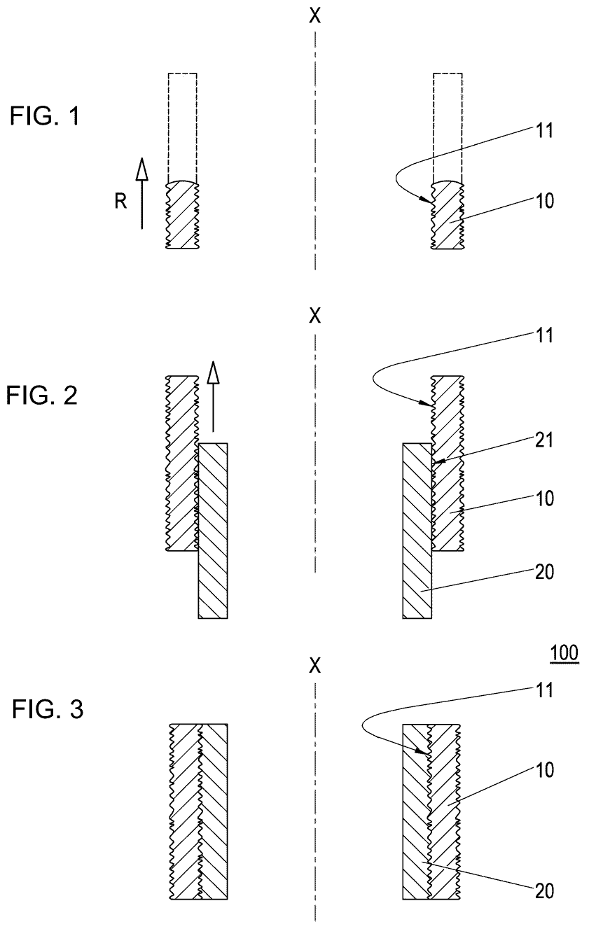

FIG. 1 illustrates how, according to a step of a method according to the disclosure, a metal sleeve 10 is correspondingly manufactured additively in a building-up direction R, the finished metal sleeve being indicated by dashed lines. The metal sleeve 10 is in this case shown in a sectional view along its central axis X.

As can be seen in FIG. 1, a multiplicity of unevennesses (bumps/grooves/ridges), in particular on an inner surface 11 of the metal sleeve, are formed during the additive manufacturing.

In a further step of the method according to the disclosure, a plastic tube piece 20 is introduced into the metal sleeve 10. This is illustrated in FIG. 2 in a corresponding sectional view, wherein in the present case the plastic tube piece 20 is pushed into the interior of the metal sleeve in the direction of the arrow. It goes without saying that, as an alternative or in addition, the metal sleeve 10 could be moved, and pushed onto the plastic tube piece 20, in the direction opposite the direction of the arrow (not shown).

As can be seen from FIG. 2, after the introduction (and before the cooling of the metal sleeve), the inner surface 11 of the metal sleeve and an outer surface 21 of the plastic tube piece 20 are in encircling contact, but still bear against one another so as to be displaceable with respect to one another.

As a result of the residual heat still resulting from the additive manufacture, in the present case, during the introduction of the plastic tube piece 20, the metal sleeve 10 has a temperature which is at least as high as a melting temperature of the plastic tube piece (or of its material). Thus, the plastic tube piece 20 introduced is incipiently melted, that is to say softened (not visible), in the region of its outer surface 21. As an alternative or in addition, it would also be possible for the metal sleeve to be heated externally, for example by means of induction loops or a furnace, in order to soften the plastic.

After the introduction, according to the disclosure, the metal sleeve 10 is allowed to cool, and/or actively cooled, and in this way a press fit of the plastic tube piece 20 in the metal sleeve 10 is effected. FIG. 3 shows the resulting exemplary ring-shaped or tubular component 100 according to the disclosure, in which the unevennesses in the inner surface 11 of the metal sleeve 10 have, on account of the shrinkage pressure of the cooling metal and as a result of the softening/melting of the outer surface 21 of the plastic tube piece, been impressed into the latter. The metal sleeve 10 and the plastic tube piece 20 are consequently connected to one another particularly firmly both due to the pressing connection resulting from the shrinkage process and mechanically due to the interengaging surfaces 11, 21.

A method for producing a ring-shaped or tubular component 100 is disclosed. In this case, a metal sleeve 10 is produced by additive manufacturing and a plastic tube piece 20 is introduced into the metal sleeve 10, which still contains residual heat. By allowing the metal sleeve 10 to cool and/or even actively cooling it, press fitting of the plastic tube piece 20 is then effected.

A ring-shaped or tubular component 100 comprising a metal sleeve 10 and a plastic tube piece 20 fixed therein at least by means of a press fit is furthermore disclosed.

Representative, non-limiting examples of the present invention were described above in detail with reference to the attached drawings. This detailed description is merely intended to teach a person of skill in the art further details for practicing preferred aspects of the present teachings and is not intended to limit the scope of the invention. Furthermore, each of the additional features and teachings disclosed above may be utilized separately or in conjunction with other features and teachings to provide improved methods for producing ring-shaped or tubular components and the components produced by such methods.

Moreover, combinations of features and steps disclosed in the above detailed description may not be necessary to practice the invention in the broadest sense, and are instead taught merely to particularly describe representative examples of the invention. Furthermore, various features of the above-described representative examples, as well as the various independent and dependent claims below, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter.

### REFERENCE NUMBER LIST

10 Metal sleeve
11 Inner surface of the metal sleeve
20 Plastic tube piece 21 Outer surface of the plastic tube piece
100 Ring-shaped or tubular component
R Building-up direction for the additive manufacture
X Central axis

What is claimed is:

1. A method for producing a ring-shaped or tubular component, comprising:
using an additive manufacturing process to deposit a metal heated to above a first predetermined temperature in successive circular layers to form a metal sleeve,
introducing a tube piece comprising a plastic into the metal sleeve while a temperature of the metal sleeve remains above a second temperature, and
actively or passively cooling the metal sleeve to form a press fit between the tube piece and the metal sleeve.

2. The method according to claim 1,
wherein the second temperature is greater than or equal to a melting temperature of the plastic.

3. The method according to claim 1,
wherein the additive manufacturing process produces an uneven inner surface of the metal tube.

4. The method according to claim 3,
wherein the plastic comprises a thermoplastic.

5. The method according to clam 4, wherein the thermoplastic comprises polyurethane.

6. The method according to claim 4,
wherein at least one portion of the metal sleeve has a constant or mean outer diameter greater than or equal to 8 cm.

7. The method according to claim 6,
wherein the constant or mean outer diameter is less than or equal to 50 cm.

8. The method according to claim 6,
wherein the constant or mean outer diameter is greater than or equal to 9 cm and less than or equal to 12 cm.

9. The method according to claim 4,
wherein at least one portion of the metal sleeve has a constant or mean outer diameter at least 120 cm and/or at most 170 cm.

10. A stern bush tube of a watercraft produced by the method according to claim 4.

11. A method for producing a stern bush tube of a watercraft, comprising:
using an additive manufacturing process to deposit a metal heated to above a first predetermined temperature in successive circular layers to form a metal sleeve,
introducing a tube piece comprising a plastic into the metal sleeve while a temperature of the metal sleeve remains above a second temperature, and
actively or passively cooling the metal sleeve to form a press fit between the tube piece and the metal sleeve.

12. The method according to claim 11,
wherein the second temperature is greater than or equal to a melting temperature of the plastic.

13. The method according to claim 11,
wherein the additive manufacturing process produces an uneven inner surface of the metal tube.

14. The method according to claim 13,
wherein the plastic comprises a thermoplastic.

15. The method according to clam 14, wherein the thermoplastic comprises thermoplastic polyurethane.

16. A stern bush tube of a watercraft produced by the method according to claim 14.

17. A stern bush tube of a watercraft comprising:
a metal tube formed by an additive manufacturing process in a manner that results in an uneven inner surface of the metal tube, and
a plastic tube press fit in an interior of the metal tube with a portion of an outer surface of the tube melted to conform to the uneven inner surface.
